(19) United States
(12) Patent Application Publication
(10) Pub. No.: US 2017/0132581 A1
(43) Pub. Date: May 11, 2017

(54) Mobile Wireless Object Recognition and Control

(71) Applicants: Kendyl A. Roman, Sunnyvale, CA (US); John Livacich, Sunnyvale, CA (US)

(72) Inventors: Kendyl A. Roman, Sunnyvale, CA (US); John Livacich, Sunnyvale, CA (US)

(73) Assignee: Evrio, Inc., Santa Clara, CA (US)

(21) Appl. No.: 15/415,887

(22) Filed: Jan. 26, 2017

Related U.S. Application Data
(63) Continuation of application No. 13/525,275, filed on Jun. 16, 2012.

(51) Int. Cl. G06Q 10/00; G06K 9/18; G06F 19/00; G06K 9/00; G06Q 10/06; G06Q 10/08

(52) U.S. Cl. CPC G06Q 10/20; G06Q 10/063114; G06Q 10/0875; G06F 19/327; G06K 9/00201; G06K 9/00288; G06K 9/00006; G06K 9/00597; G06K 9/183

(57) ABSTRACT

A system, handheld devices, and methods for object tracking and control. The system tracks and controls items, users, including medical practitioners, patients, and their interactions. The handheld mobile wireless device provides item specific information, instruction, and supervision. A plurality of handheld devices is configured to be used by different users, and communicate with a central database. A handheld device comprises a camera for scanning an image of an object, a display for displaying information, and a wireless network connection to the database server. The system recognizes the object and identifies a person. The database includes information regarding people and their roles, permissions, and authorized or assigned tasks; objects and tools; object specific instructions; and the handheld devices. An observer, or the system, can monitor the performance of the tasks, and provide corrective feedback.

### RELATED APPLICATIONS

This application is a continuation-in-part (CIP) of our pending U.S. patent application Ser. No. 13/525,275, filed Jun. 16, 2012 and claims benefit of the Jun. 16, 2012 filing date. U.S. patent application Ser. No. 13/525,275 is included by reference.

Our U.S. patent application Ser. No. 13/525,273, now U.S. Pat. No. 9,336,238, was also filed on Jun. 16, 2012.

### BACKGROUND

Field of Invention

The present invention relates to object recognition and control, in particular the invention relates to object recognition and control including mobile wireless devices.

Description of Prior Art

Various attempts have been made to label objects with labels that can be read automatically by a computing machine. Barcodes have proven to be an effective scheme for achieving these purposes. Originally, linear or one-dimensional barcodes such as the Universal Product Code (UPC) were used. The UPC was the first commercially successful model and enjoyed widespread universal use.

Later a two-dimensional or matrix code was developed. These are similar to one-dimensional codes, but represent more data per unit area and traditionally utilize square pixels. While the UPC represents a serial number, matrix codes can represent text, URLs, or other data. The Quick Response Code (QR Code or QRC) is one of the most popular types of two-dimensional codes and is often used with smart phones.

More recently, a third-generation barcode called the High Capacity Color Barcode (HCCB) was developed. This two-dimensional barcode uses multi-colored triangles for an increase in data density, but still represents the same types of data.

Bar code readers are typically connected to computer systems and databases to keep track of sales or inventory.

These conventional methods have many drawbacks and limitations including the inability to identify individuals in various disciplines and roles and correlate relationships, tasks, permissions, etc. with other objects and/or individuals. In addition, these methods lack the ability to provide and present training, instructional and other information in various forms for maintenance and other purposes.

There is a need for mobile wireless handheld devices to be able to recognize various objects and people and to provide for training, instruction, tracking, monitoring, and observation, which are authorized, and object specific. Further there is a need to be able to confirm that maintenance or use procedures are performed properly while they are being performed.

### SUMMARY OF THE INVENTION

It is an objective of the present invention to provide a means and method of identifying objects that include and go beyond those currently identifiable by conventional labels and go beyond existing tracking systems. Although traditional coded labels have proven to be an effective scheme for achieving item identification, they by themselves fall short of being able to achieve a more universal means and method of object recognition, training, instruction, tracking, monitoring, observation, and control. Handheld mobile wireless devices are used with objects and individuals to provide up-to-date pertinent information using methods such as on screen instructions, checklists, videos, pictures, diagrams, etc. or any combination thereof. Items and people are identified by scanning a label attached to the item or person, or by use of object recognition, facial recognition, or other biological recognition, such as iris scan, fingerprint scan, or other recognition known in the art. The system tracks and controls items, people, and their interactions. The handheld mobile wireless device provides item specific information, instruction, and supervision.

A system aspect of the invention comprises a plurality of handheld devices used by different people, and a database in communication with the handheld devices.

A handheld device comprises a camera for scanning an image of an object, a display for displaying information, and a wireless network connection to the database for sending and receiving data.

The system recognizes the object by interpreting the image. In some embodiments, a coded label, e.g. a UPC or QR code, is interpreted. The system also identifies a person. The person may be identified by being associated with the handheld device; by scanning a scan label, such as an ID badge, ID card, or tattoo; or by scanning a face, a fingerprint, an iris, or other biometric. Voice recognition may also be used to identify the person.

The database includes information regarding people and their roles, permissions, and authorized or assigned tasks; objects and tools; object specific instructions; and the handheld devices. The database also records information regarding the interaction between the objects and the people. The database resides on at least one database server that manages the database and executes a variety of computer programs that create, access, modify, and delete the data in the database. The server may contain artificial intelligence programs which perform object recognition, facial recognition, biometric recognition, and voice recognition.

The roles include maintenance, use, and observation, and may vary based on the object.

The object specific instructions include documents, checklists, pictures, audio, and video. The object specific instructions are of different types and formats which are compatible with different types of hand held devices.

When the handheld device scans an object, the object is recognized, the person and their role are identified, and if the person is authorized the handheld device provides object specific instructions to the person from the database.

In some situations, an observer is notified when use, or maintenance, is started by another person who is a user, or a maintainer, respectively.

An observer, or in some embodiments, the automated system, can monitor the proper performance of the tasks, and provide corrective feedback during the performance.

Method aspects of the invention include capturing an image with the camera of the handheld device, interpreting the image, determining an object, determining a person, and if the person is authorized determining a role of the person.

A method of performing maintenance includes identifying a current part and any associated tools, providing object specific instructions for the current maintenance task, confirm completion of the task, and recording completion of the task, and repeating for each maintenance task.

A method of performing use includes identifying tools, if any, providing object specific instructions for the current use task, confirm completion of the use, and recording information regarding the use, and repeating for each use task.

A method of performing observation includes providing object specific instructions if required, and recording information regarding the start and finish of the observation, and repeating for each observation task.

### OBJECTS AND ADVANTAGES

Accordingly, the present invention includes the following advantages:
1. To provide a means and method of object recognition and control.
2. To provide a means and method of recognition and control of people.
3. To provide a means and method of object recognition and control has a common repository.
4. To provide a means and method of object recognition and control that is role based.
5. To provide a means and method of object recognition and control that is discipline based.
6. To provide a means and method of object recognition and control that is used for verification and ratification.
7. To provide a means and method of object recognition and control that is used for maintenance notification, instructions, and tracking.
8. To provide a means and method of object recognition and control that is used to log maintenance and events.
9. To provide a means and method of object recognition and control that is used for reporting.
10. To provide a means and method of object recognition and control that is used for presenting information in a variety of mediums including documents, pictures, diagrams, video, audio, etc.
11. To provide a means and method of object recognition and control that is used for problem solving via knowledge bases that are associated with objects and individuals.
12. To provide a means and method of object recognition and control that is easy to use.
13. To provide a means and method of object recognition and control that is quick and effective.
14. To provide a means and method of object recognition and control that is cost effective.
15. To provide a means and method of object recognition and control that simplifies procedures.
16. To provide a means and method of medical object recognition and control that allows easier access to patient information.
17. To provide a means and method of medical object recognition and control for a medical practitioner to efficiently and quickly identify and treat patients.
18. To provide a means and method of medical object recognition and control for a medical practitioner to accurately treat patients.

### DRAWING FIGURES

In the drawings, closely related figures have the same number but different alphabetic suffixes.

FIG. 1A through FIG. 1C show prior art coded labels, such as bar codes and QR codes.

FIG. 2 illustrates the system with people with different roles and separate handheld devices communicating with the same database and server.

FIG. 3A through FIG. 3D illustrate flowcharts of showing the exemplary steps for the methods of the system.

FIG. 4 illustrates the structure of the database.

FIG. 5A shows a user with a mobile wireless device with various objects and cameras for remote observation.

FIG. 5B illustrates a medical practitioner with a mobile device with patients and medical devices and cameras for remote observation.

FIG. 6A through FIG. 6C illustrate an example of guided maintenance using coded labels.

FIG. 7A through FIG. 7C illustrate an example of guided maintenance without using coded labels, using object recognition instead of coded labels.

### REFERENCE NUMERALS IN DRAWINGS

100 a-d coded label
101 universal product code (UPC)
102 quick response (QR) code
103 high capacity color barcode (HCCB)
120 a-c scan label
200 a-c object
210 a-e handheld device
211 a-c image data
212 a-c outgoing database information
213 a-c incoming database information
220 maintainer
230 user
240 observer
250 database
300 start
301 path
302 capture image
303 path
304 interpret image
305 path
306 determine object
307 path
308 determine person
309 path
310 is person authorized
311 path
312 determine role
313 path
314 no access
315 path
316 maintenance?
317 path
318 perform maintenance
319 path
320 use?
321 path
322 perform use
323 path
324 observe?
325 path
326 perform observation
327 path
329 path
331 path
332 identify part
333 path
334 identify tools
335 path
336 provide instruction
337 path
338 notify observer of start
339 path
340 confirm completion
341 path
342 record completion
343 path
344 notify observer of completion
345 path
346 more tasks?
347 path
348 exit
349 path
350 path
351 path
352 tools required?
353 path
354 identify tools
355 path
356 provide instruction
357 path
358 notify observer of start
359 path
360 confirm use
361 path
362 record use
363 path
364 notify observer of completion
365 path
366 more tasks?
367 path
368 exit
369 path
370 path
371 path
372 instruction needed?
373 path
374 provide instruction
375 path
376 record observation start
377 path
378 communicate with others
379 path
380 record observation finish
381 path
382 more tasks?
383 path
384 exit
385 path
400 roles
402 people
404 objects (tools)
406 tasks
408 task list
410 devices
500 patient
510 tool
520 mounted camera
530 satellite camera
540 overhead camera
550 mounting structure
560 drone
570 satellite
610 box assembly
620 door
630 door handle
640 outer part
650 inner part

### DESCRIPTION OF THE INVENTION

### Prior Art Coded Labels

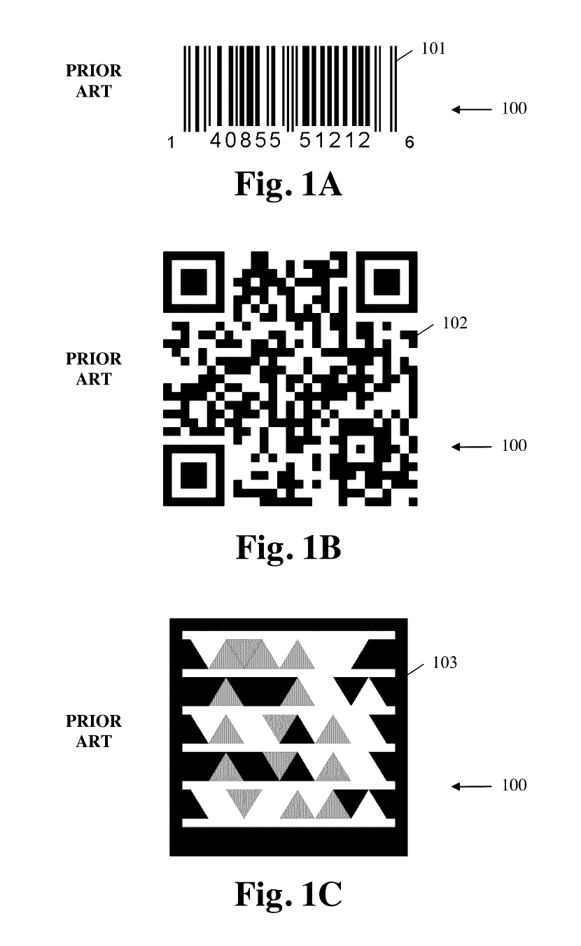

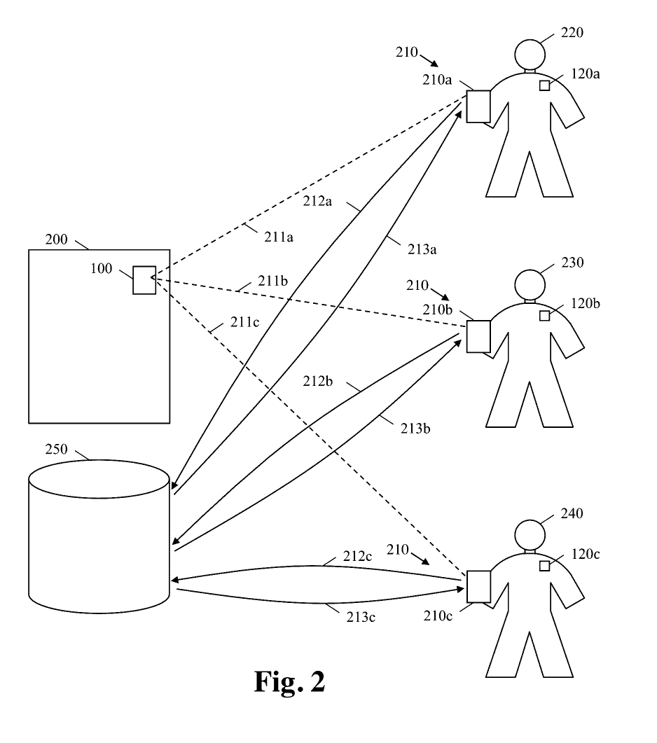

FIG. 1A through FIG. 1C show prior art coded labels 100.

FIG. 1A illustrates an example of a coded label 100 with a barcode, in particular universal product code (UPC) 101. A barcode or UPC typically represents a number. The UPC system allows each product to have a unique code making the system universal. However, individual products can only be identified with an additional label such a serial number barcode.

FIG. 1B illustrates an example of a coded label 100 with a quick response (QR) code 102. A QR code 102 has high data density. It can encode free form text and is typically used to encode a direct address of other information such as an URL.

FIG. 1C illustrates an example of a coded label 100 with a high capacity color barcode (HCCB) 103. A HCCB may also contain a direct address such as an URL.

### Handheld Devices Used for Object Recognition and Control and Instruction

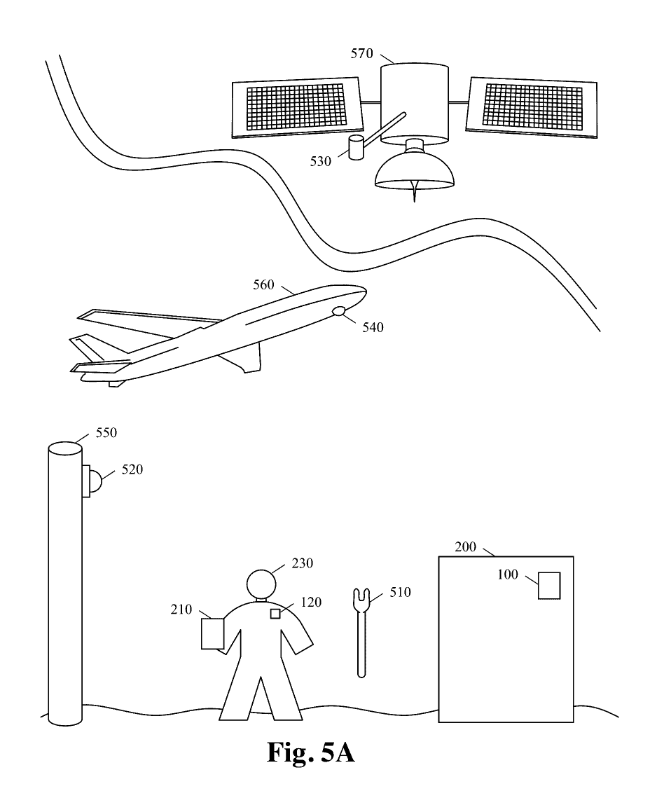

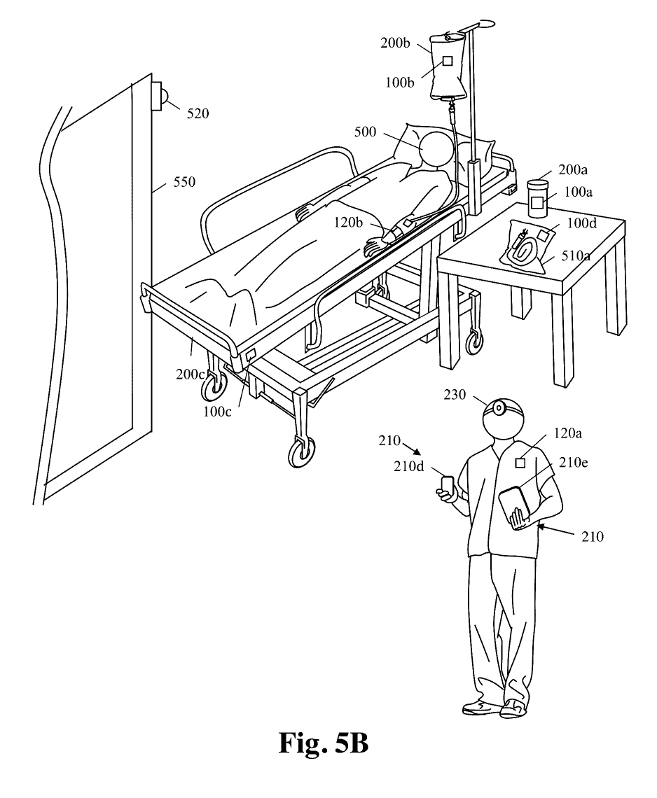

FIG. 2 illustrates a system with people with different roles and separate handheld devices communicating with the same database and server. Each person is shown with a handheld device 210 (shown in FIGS. 2 as 210a, 210b, and 210c, respectively, and shown in FIG. 5B as 210d and 210e). The handheld device 210 is preferably a mobile wireless device. The handheld device 210 includes a camera, which can scan an image of an object 200. A coded label 100 on object 200 is initially scanned as image data 211a-c by any of the handheld devices 210a-c, which is operated by a maintainer 220, a user 230, and/or an observer 240, respectively. The observer 240 can be a manager, supervisor, or team leader, etc. The handheld devices 210a-c each interacts with the same database 250 to send and receive information. Information sent to the database 250 is outgoing database information 212a-c respectively. For example, when maintainer 220 scans the coded label 100 on object 200, the image data 211a is interpreted by the handheld device 210a and the decoded data is sent to the database 250 as outgoing database information 212a. The maintainer 220 may also be recognized, for example, by scanning scan label 120a. Information sent from the database 250 to the handheld devices 210a-c is incoming database information 213a-c, respectively. Incoming database information 213 may be directed to the maintainer 220, the user 230, and/or the observer 240. The information in database 250 can include instructions, tools list and maintenance logs. The data in the database 250 may describe each person's role, authorization, security access or other information. For example, after receiving the decoded data from the handheld device 210a, incoming database information 213a sent to the maintainer 220 would include instructions and a list of tasks, which may be customized to the specific maintainer 220 (as identified e.g. by scan label 120a). The maintainer 220 may receive information about the parts on or in the identified object 200. The maintainer 220 may also receive instructions on how to perform the maintenance and the tools necessary. The maintainer 220 may be shown a video series on the handheld device 210a showing each of the steps of the required maintenance. A local handheld device (e.g. 210a) may detect whether or not the proper steps were performed. The observer 240 may be in a remote location, and may receive information about the maintainer 220, or the user 230, information on progress updates, and visual data (pictures and/or video) to oversee the tasks being performed.

The communication paths for the outgoing database information 212a-c and the incoming database information 213a-c are preferably wireless, such as WiFi or 3G or 4G wireless network protocols.

The mobile wireless handheld devices 210a-c can communicate directly to each other as enabled by the database 250, or may communicate using the database 250 as a teleconferencing server.

In some embodiments, the observer 240 observes using conventional computer or video conferencing equipment, rather than using a handheld device 210c.

### Exemplary Operation

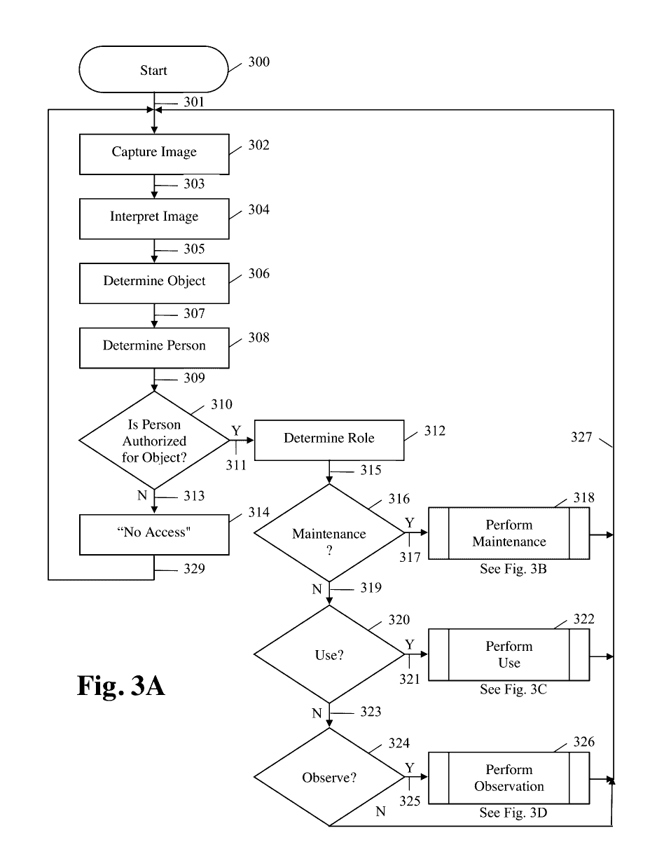

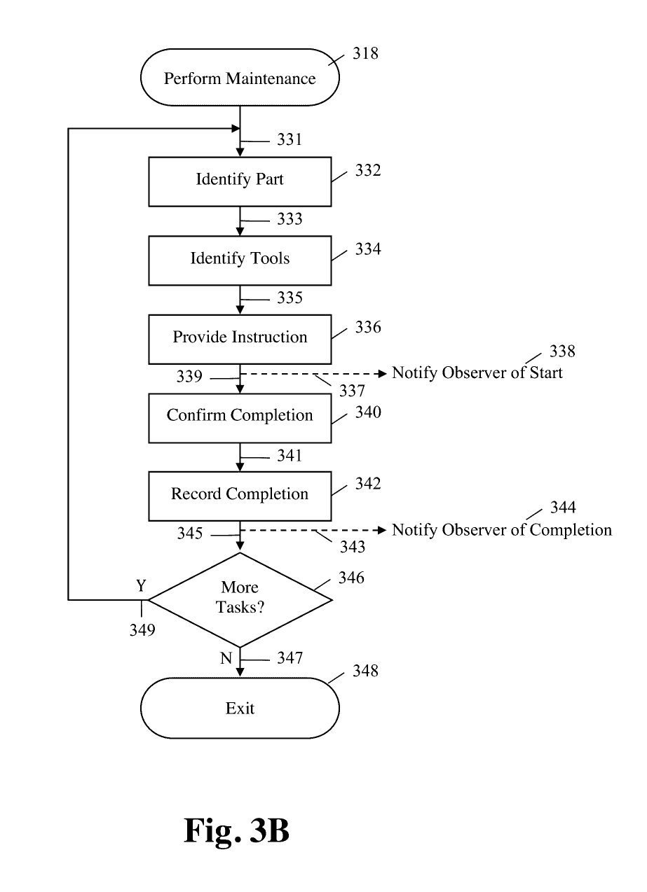

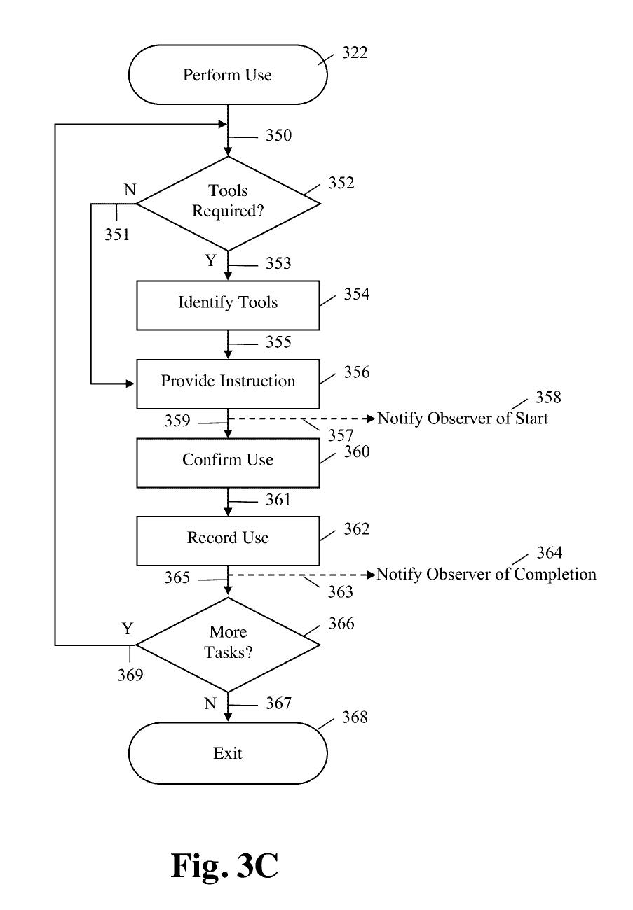

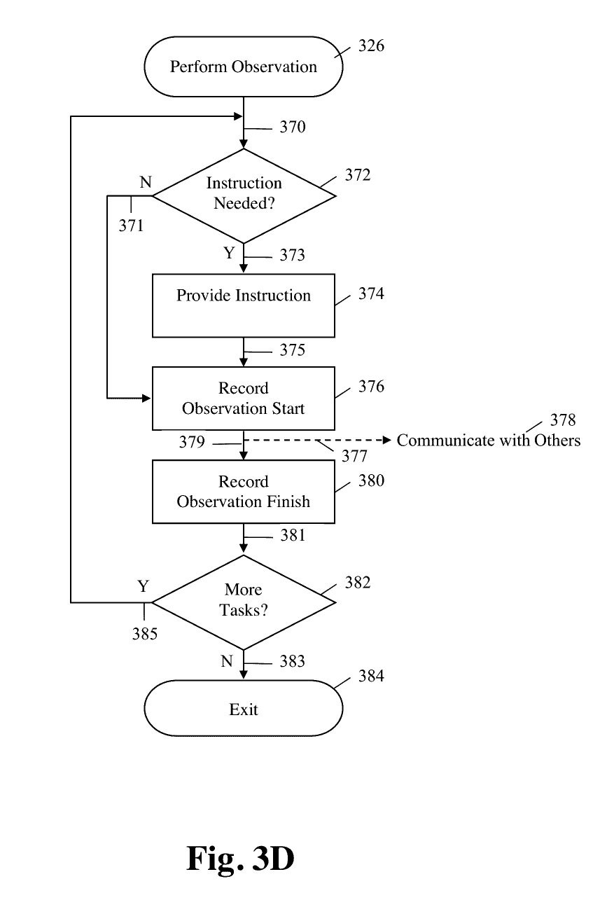

FIG. 3A through FIG. 3D provide flowcharts for method aspects of an embodiment of the invention. Other embodiments may omit or add steps, or perform steps in different orders.

FIG. 3A is a top-level flowchart. The process starts at step 300 and moves along path 301 to a capture image step 302 where the image is captured by a handheld device 210. The process moves along path 303 to an interpret image step 304 where the image is interpreted. The image may be interpreted by the handheld device 210 or by the database 250. Then the process moves along path 305 to a determine object step 306 where the object is determined from data stored in the database based on the image data 211. Then the process moves along path 307 to a determine person step 308. The person may be determined based on a device code unique to the handheld device (e.g. 210a or 210b), by the scan label (e.g. 120a or 120b), or by a face, fingerprint, or iris scan. This checks the identity of the individual running the handheld device 210. The process then moves along path 309 to a decision 310 where it checks if the person is authorized for object. If not, the process moves along path 313 to “No Access” step 314 where it will send a message stating “No Access” and moves along path 329 back to path 301. If yes, the process moves along path 311 to a determine role step 312 where the role will be determined for the person determined in step 308. Then the process decides which sub-process to perform based on the role: maintenance, use, or observation. First the process moves along path 315 to maintenance? decision 316 to decide if the role is maintenance. If yes, the process moves along path 317 to perform maintenance step 318 (see FIG. 3B) and then moves along path 327 back to path 301. If not, the process moves along path 319 to use? decision 320 to decide if the role is use. If yes, the process moves along path 321 to perform use step 322 (see FIG. 3C) and then moves along path 327 back to path 301. If not, the process moves along path 323 to observe? decision 324 to decide if the role is observe. If not the process moves along path 327 back to path 301. If yes, the process moves along path 325 to perform observation step 326 (see FIG. 3D) and then moves along path 327 back to path 301.

In some embodiments, the perform observation step 326 is triggered independently, for example, by the notify observer of the start of maintenance message 338 in FIG. 3B or by the notify observer of the start of use message 358 in FIG. 3C. In those embodiments, the observer 240 does not need to scan the object's label, but instead may be optionally identified by their handheld device 210c or by scanning their ID scan label 120c, and associated with the observer role by data stored in the database. In other embodiments the observer 240 is identified by the conventional computer or video conferencing equipment they are using or by their physical location.

FIG. 3B is a flowchart for the perform maintenance 318 process. The process begins along path 331 to an identify part step 332 where a maintenance part is determined. Next the process moves along path 333 to an identify tools step 334, where the tools associated with the current maintenance part are identified. The process moves along path 335 to a provide instruction step 336. Instructional information regarding the current maintenance part, use of tools, how the maintenance is performed is provided, for example, as incoming database information 213a from the database 250 to the handheld device 210a. The instructional information could include videos of the maintenance process. At event 337, a notify observer of the start of maintenance message 338 is sent. The handheld device 210c associated with the observer 240 is notified along communications path 213c. The observer can observe the maintenance procedure via pictures, audio, and/or video transmitted to the handheld device 210c (or in some embodiments, to conventional computing or video conferencing equipment). The information in message 338 is sufficient to automatically authorize and enable the observer 240 to observe the maintenance without requiring further actions by the observer 240. The observer 240 can watch what is happening and will subsequently wait for confirmation of the maintenance completion. When the maintenance is completed, the process moves along path 339 to the confirm completion step 340, the handheld device 210a will send completion information back to the database 250. The process will then move along path 341 to a record completion step 342 where the completion of the task is recorded in the database 250. The database 250 can log the time and date of the maintenance as well as logging the person who performed the maintenance, the tools used, how long it took, and so forth. At event 343, a notify observer of the completion of maintenance message 344 is sent. The observer 240 could verify that the maintenance was performed as required and can then turn attention to other matters. The optional verification could include sending a verification message to the database 250. Then the process moves along path 345 to more tasks? decision 346 to determine if there are more maintenance tasks. If so, the process moves along path 349 to path 331 to repeat the cycle. If not, the process moves along path 347 to exit 348.

FIG. 3C is a flowchart for the perform use 322 process. The process begins along path 350 to a tools required? decision 352. If so, the process moves along path 353 to an identify tools step 354 where tools are identified and continues along path 355. If not, the process moves along path 351 and skips step 354. At a provide instruction step 356, information regarding use, and tools if applicable, is provided to the handheld device 210b of the user 230. The instruction could include a checklist, pictures, audio, and/or video. At event 357, a notify observer of the start of use message 358 is sent. The handheld device 210c associated with the observer 240 is notified along communications path 213c. The observer 240 can observe the use via pictures, audio, and/or video transmitted to the handheld device 210c (or in some embodiments, to conventional computing or video conferencing equipment). The observer 240 may wait for notice of use completion. When use is completed, the process moves along path 359 to the confirm use step 360, the handheld device 210b will send use information back to the database 250. The process will then move along path 361 to a record use step 362. The database 250 can log the time and date of the use as well as logging the person who performed the use, the tools used, how long the object was used, and so forth. At event 363, a notify the observer of the completion of use message 364 is sent. Then the process moves along path 365 to more tasks? decision 366 to determine if there are more use tasks. If so, the process moves along path 369 to path 350 to repeat the cycle. If not, the process moves along path 367 to exit 368.

FIG. 3D is a flowchart for the perform observation 326 process. The process begins along path 370 to an instruction needed? decision 372. If so, the process moves along path 373 to a provide instruction step 374, where instruction regarding the observation is provided, and continues along path 375. If not, the process moves along path 371 and skips step 374. At the provide instruction step 374, information is provided to the handheld device 210c of the observer 240. The instruction could include a checklist, pictures, audio, and/or video. In record observation start step 376, it is noted that the observer 240 has started the observation. During the observations, at event 377, the observer 240 may communication with others, e.g. the maintainer 220 or the user 230. The communication with others 378 could be instructional, corrective or supportive information. The handheld device 210c associated with the observer 240 will send communication 378 to other handheld devices (e.g. 210a and 210b). When the observer 240 stops observing, the process moves along path 379 to the record observation finish step 380, the handheld device 210c will send observation information back to the database 250. The database 250 can log the time and date of the observation as well as logging the person who observed, how long the observation took, the types of communication that occurred during the observation, and so forth. Then the process moves along path 381 to more tasks? decision 382 to determine if there are more observation tasks. If so, the process moves along path 385 to path 370 to repeat the cycle. If not, the process moves along path 383 to exit 384.

### Database

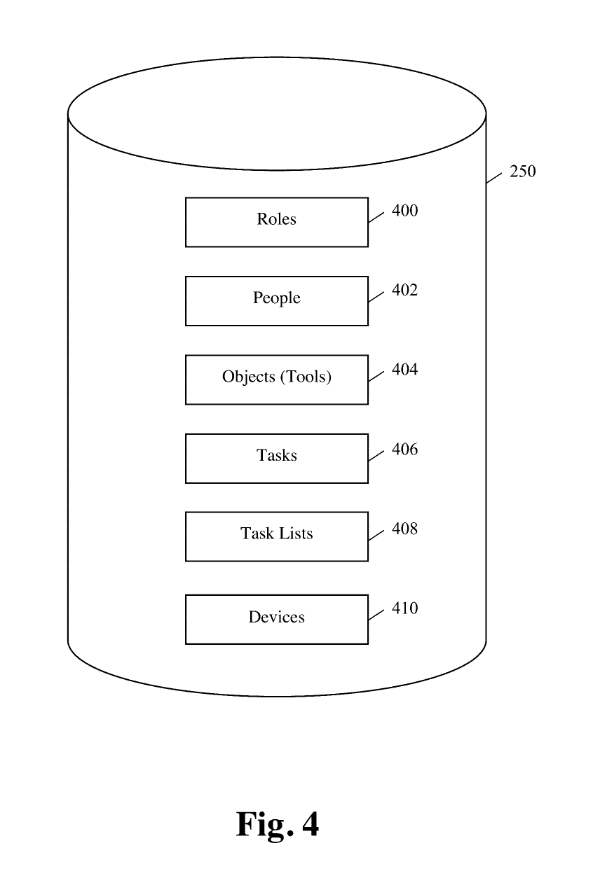

FIG. 4 illustrates the types of information that the database 250 will hold and maintain. The database 250 can be any data repository including relational, hierarchical, etc. The data schema will support various entities including roles 400, people 402, objects 404 (including objects 200 and tools and supplies 510), tasks 406, task lists 408, and devices 410. The storage of this information on a single, centrally accessible database is valuable to proper communication and coordination.

The data regarding roles 400 include the roles of various people associated with various objects. For example, an individual may be a maintainer of a particular object, such as a machine, but may be a user of another object, such as a tool used to fix the machine. The individual may also be a supervisor for another maintainer and will be notified as an observer whenever the maintainer they supervise is performing maintenance. Thus the same individual may have the role of maintainer, user, and observer. These relationships are tracked in the roles 400, people 402, and objects (tools) 404 data tables.

Means for identifying people such as ID badges, fingerprints, face scans, or iris scans are stored in the people 402 data table. Relationships of people 402 to roles 400, objects 404, task lists 408, and devices 410 are also tracked in the database.

Object specific tasks 406 and instructions associated with those tasks are stored in the tasks 406 portion of the database. Object specific instructions may include documents, checklists, pictures, audio, and/or video.

### Exemplary Use

FIG. 5A shows how a user 230 can use a handheld device 210 and various communication methods. The user 230, identified by the scan label 120, can access information from the handheld device 210. A remote observer 240 can observe using various cameras, such as mounted camera 520 shown on a mounting structure 550, shown as a pole, an overhead camera 540 shown mounted on an airplane or drone 560, or even a satellite camera 530 mounted on a satellite 570. The handheld device 210 can identify object 200 by reading coded label 100 to review maintenance history, to determine what tasks are to be performed using the object 200, and to get more information regarding the object 200. The database 250 can assimilate this information and determine whether the user 230 will need tools such as tool 510 for a particular use (or maintenance task). At the same time, the system tracks that the specific user 230 is interacting with the object 200. The system can notify one or more observers 240 who are required to observe or who may be interested and authorized to observe. The system may automatically observe. For example, if tool 510 is required, the system can notify the user 230, provide instructional information, including video information to the user 230 via the handheld device 210, and the monitor the use to ensure that it is performed properly. If the use (or maintenance task) is not performed properly, the system, or an observer 240, can correct the situation while the user 230 is on site and performing the task. Further, if there is a problem, additional instruction may be provided via pictures, audio, and/or video. Details of the use or maintenance, and optional observation, are stored in the database as part of the maintenance or use history and can be used to improve procedures, training, and safety.

In some embodiments, the mounted camera 520 (or even a satellite camera 530) can scan all of the coded labels 100 and scan labels 120 as well as recognize objects 200 and tools 510. Once a user 230 and the object 200 are identified in proximity, the system could instruct the user 230 via the handheld device 210 to perform the procedure. The system could observe the entire interaction and provide instruction prior to each task as well as providing corrective feedback and instruction when the wrong actions or parts are observed. The system would also record information regarding the user 230, the object 200, and the interactions.

FIG. 5B shows how a user 230, such as a medical practitioner or medical technician, can use a handheld device 210 and various communication methods. The user 230 identified by the scan label 120 can access information from the handheld device 210. The handheld device 210 could be pocket sized such as an Apple iPhone, Android phone or other smart phone 210d or a tablet such as an Apple iPad, Amazon Kindle or other handheld tablet 210e. Characteristics of different devices are stored in the device data tables 410 and can be used to select the format of object specific instructions. A remote observer 240, such as an ordering physician, a monitor technician, or a nurse manager, can observe using various cameras, such as mounted camera 520 shown on a mounting structure 550, shown as a wall. The handheld device 210 can identify patient 500 by reading scan label 120b to review health history to determine what tasks are to be performed regarding the patient 500, and to get more information regarding the patient 500. In some embodiments, the patient data may include a photograph, a fingerprint, or an iris scan to double check the patient's ID. The database 250 will determine if the practitioner 230 is authorized to work with the patient 500. If so, the user-specific workflow will be displayed, such as tasks, medications, and procedures. The system also determines whether the specific medical practitioner/technician is authorized to perform the task, such as a) give medication 200a b) start IV bag 200b, or c) repair or calibrate a device.

In the example of giving a medication, the handheld device 210 (e.g. 210d or 210e) can identify the drug container 200a by reading coded label 100a and display the corresponding drug order to determine how the drug is to be administered and what is the proper dosing, to confirm that the right drug is being given to the right patient, and to check for drug interactions. The handheld device 210 matches the medication with the order and performs dosage calculations (e.g. weight or potassium (K+) level with cross check to most recent lab data). The database 250 can track exactly when the drug was given, to whom it was given, and who gave it.

In the example of starting an IV bag 200b, the handheld device 210 can identify the IV bag 200b by reading coded label 100b, display the drug order, determine what is the proper dosing, and confirm that the right drug is being given to the right patient. The database 250 can assimilate this information and determine whether the user 230 will need tools or materials, such as IV tubing 510a or a catheter, for this particular medical task. The database 250 can track exactly when the IV was started, to whom it was given, and who gave it. It can also track when the IV tubing 510a, or a catheter, was first used and thus when it needs to be replaced.

If a procedure is to be done, such as an IV or catheter, the handheld device 210 scans the medical device's code label, such as 100b for the IV bag 200b, 100c for the hospital bed 200c, or 100d for the IV tubing 510a. The handheld device 210 confirms the proper device, calibration, maintenance, etc. and provides an on-screen checklist and instructions, such as pictures, audio, and/or video.

At the same time, the system tracks that the specific practitioner 230 is interacting with the patient 500 or the drug 200a or IV bag 200b. The system can notify one or more observers 240 who are required to observe or who may be interested and authorized to observe. The system may automatically observe. For example, if a specific material or tool 510 (such as IV tubing 510a) is required, the system can notify the user 230, provide instructional information, including video information to the user 230 via the handheld device 210, and the monitor the use to ensure that it is performed properly. If the procedure is not performed properly, the system, or an observer 240, can correct the situation while the user 230 is with the patient 500 and performing the task. Further, if there is a problem, additional instruction may be provided via pictures, audio, and/or video. Details of the performance of the procedure, and optional observation, are stored in the database 250 as part of the overall medical history and record, and can be used to improve procedures, training, and safety.

In some embodiments, the mounted camera 520 can scan all of the coded labels 100 and scan labels 120 as well as recognize medical objects 200, tools 510, and patients 500. Once a practitioner 230, a patient 500, and a medical object 200 are identified in proximity, the system could instruct the practitioner 230 via the handheld device 210 to perform the procedure. The system could observe the entire interaction and provide instruction prior to each task as well as providing corrective feedback and instruction when the wrong actions or medications or materials are observed. The system would also record information regarding the practitioner 230, the patient 500, the medical object 200, and the interactions. The recorded information can be stored in the database 250 and reviewed at a later time.

### Guided Maintenance

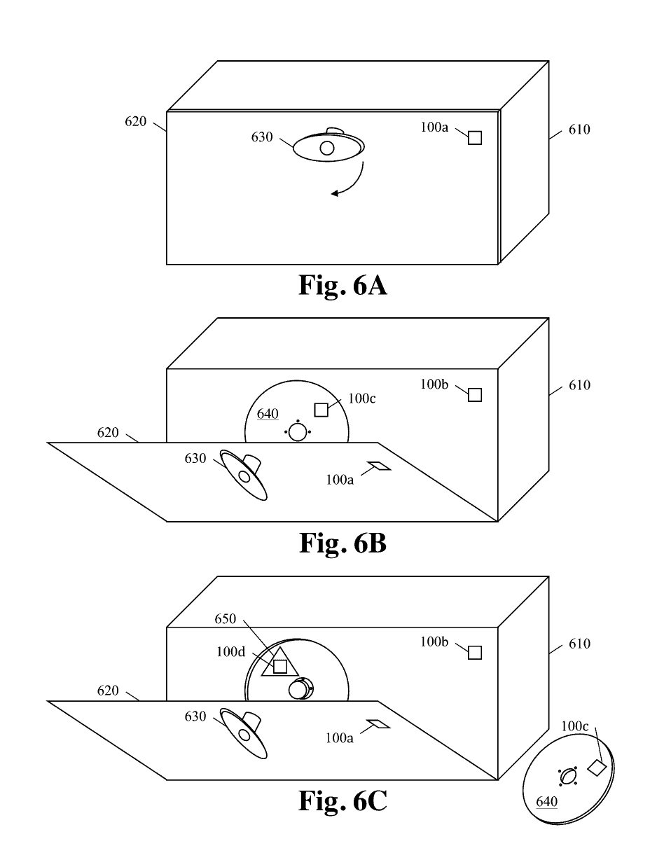

FIG. 6A through FIG. 6C illustrate an example of guided maintenance using coded labels.

FIG. 6A shows a box assembly 610. It has a coded label 100a for identification on the upper right-hand corner of the door 620. The assembly door 620 can be opened by turning the door handle 630. In this example, the handheld device 210 would image the object, box assembly 610, including the coded label 100a. The system would determine the proper maintenance procedure for the particular box assembly 610. The system would also confirm that status of the box assembly 610, e.g. that the door 620 is closed.

At this point, the handheld device 210 would provide the maintainer 220 with an overview of the maintenance procedure that is required. This instruction could include a checklist, pictures, audio, and/or video. In this example, the instructions would show how to open the door.

FIG. 6B shows the box assembly 610 with its door 620 opened. The door handle 630 has also been turned. The opened door 620 with coded label 100a exposes another coded label 100b on the body of the box assembly 610 and another outer part 640. The coded label 100c identifies the outer part 640, while the coded label 100b is used to help the handheld device recognize that the door 620 is opened.

At this point, the handheld device 210 recognizes that the door has been properly opened, that the outer part 640 is the expected internal part. Instructions are then provided for the next step, e.g. removing the outer part 640.

FIG. 6C shows a box assembly 610 as in FIG. 6B with its door 620 opened. The outer part 640 with coded label 100c has been removed exposing the inner part 650 with coded label 100d. The outer part 640 has been placed along side the box assembly 610. The inner part 650 has a coded label 100d to not only identify the inner part 650, but also to help the handheld device recognize that the outer part 640 has been removed.

At this point, the handheld device 210 recognizes that the outer part 640 has been properly removed, that the inner part 650 is the expected part. Instructions are then provided for the next step, e.g. replacing the inner part 650. When the inner part 650 has been replaced, the details of the replacement are recorded in the database 250. The system can also track who did the replacement, how long it took, and any problems encountered.

The system would also provide instruction and tracking of the reassembly of the box assembly.

This example has been exemplary but the same principles could apply to any piece of equipment.

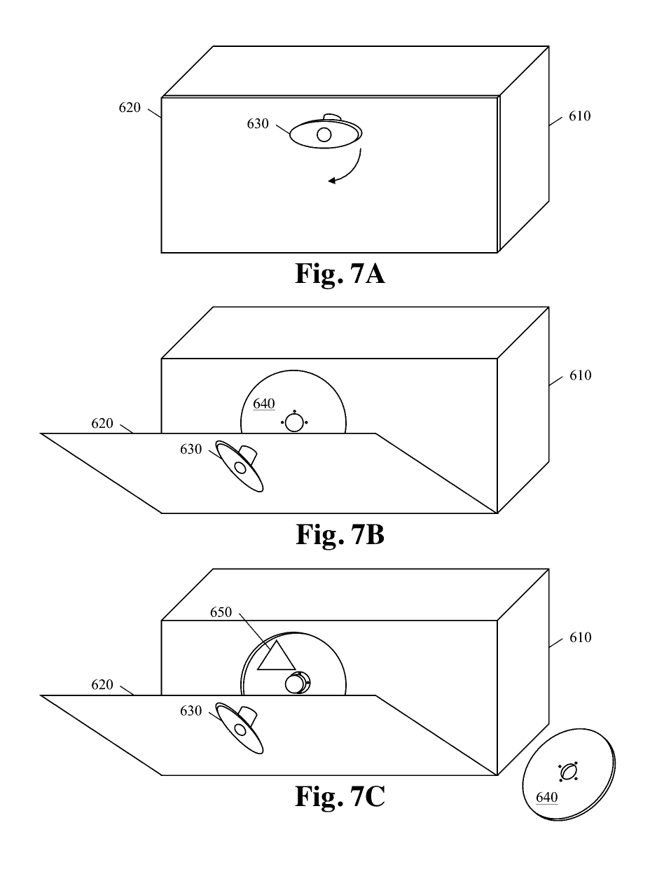

FIG. 7A through FIG. 7C illustrate an example of guided maintenance without using coded labels.

All the parts in FIG. 7A through 7C for the box assembly 610 and the maintenance are identical to the ones described in FIG. 6A through 6C with the exception of not having coded labels 100a-d. In this embodiment, the invention would identify all of the parts without the use of coded labels 100. Instead the handheld device 210 would use object recognition to determine the status of the maintenance process and to determine which parts were visible at any point in the process. The database 250 could store images showing what is expected at each point in the procedure and the system can compare what is being scanned by the cameras (of the handheld device 210, or mounted camera 520) with what is in the database 250.

FIG. 7A shows a box assembly 610. The assembly door 620 can be opened by turning the door handle 630. In this example, the handheld device 210 would image the object, box assembly 610. The system would determine the proper maintenance procedure for the identified box assembly 610. The system would also confirm that status of the box assembly 610, e.g. that the door 620 is closed.

At this point, the handheld device 210 would provide the maintainer 220 with an overview of the maintenance procedure that is required. This instruction could include a checklist, pictures, audio, and/or video. In this example the instructions would show how to open the door.

FIG. 7B shows the box assembly 610 with its door 620 opened. The opened door 620 exposes outer part 640.

At this point, the handheld device 210 recognizes that the door has been properly opened, that the outer part 640 is the expected part. Instructions are then provided for the next step, e.g. removing the outer part 640.

FIG. 7C shows a box assembly 610 as in FIG. 7B with its door 620 opened. The outer part 640 has been removed exposing the inner part 650. The outer part 640 has been placed along side the box assembly 610.

At this point, the handheld device 210 recognizes that the outer part 640 has been properly removed, that the inner part 650 is the expected part. Instructions are then provided for the next step, e.g. replacing the inner part 650. When the inner part 650 has been replaced, the details of the replacement are recorded in the database 250. The system can also track who did the replacement, how long it took, and any problems encountered.

The system would also provide instruction and tracking of the reassembly of the box assembly.

### ADVANTAGES

### Common Repository

The present invention can be used to provide a common repository for central storage of data and that can be shared among users throughout the organization and between organizations that are working together.

### Role Based

The present invention can be used to assign roles to individuals associated with various objects or tasks.

### Discipline Based

The present invention can be used to assign disciplines to individuals and provide instruction, tracking and control based on those disciplines.

### Specific Media Rich Instructions

The present invention can be used to provide instructions regarding specific objects to specific individuals in a variety of mediums including documents, checklists, pictures, audio, and/or video.

### Verification and Ratification

The present invention can be used to verify and ratify information for objects and individuals.

### Maintenance Notification and Instructions

The present invention can be used to provide maintenance notification and instructions regarding specific objects to specific individuals.

### Log Maintenance and Events

The present invention can be used to log maintenance and events for objects.

### Reporting

The present invention can be used to provide reports on given objects and individuals or a combination of the two.

### Presenting Information in a Variety of Mediums

The present invention can be used to provide information in a variety of mediums including documents, checklists, pictures, diagrams, audio and/or video.

### Problem Solving

The present invention can be used to provide the ability for problem solving via knowledge bases that can be associated with objects and individuals.

### Easy to Use

The present invention is easy to use.

### Quick

The present invention's unique design allow for quick use and time-saving when compared to conventional methods.

### Effective

The present invention is effective, allowing for multiple sources of identification and providing helpful information to streamline the work that needs to be done.

### Simplifies Medical Procedures

The present invention allows for the simplification of many medical procedures by providing correlated patient medical information to the practitioners as well as providing instruction for necessary procedures.

### Access Patient Information

The present invention allows for the access of patient information including their medical record and history. It brings up pertinent data associated with specific medicine or medical devices or materials.

### Quick Diagnosis and Treatment

With the patient data all in one place, the present invention will allow for quicker diagnoses and other medical decisions. The time saved due to the accessibility of the information will increase productivity and allow medical practitioners to see more clients and treat them more effectively.

### Accuracy of Treatment

With the patient data all in one place, the present invention will allow for more accurate treatment. It can be used to prevent the misapplication of medications or procedures.

### CONCLUSION, RAMIFICATION, AND SCOPE

Accordingly, the reader will see that the improved, universal, role and discipline based, low cost means and method of object identification, tracking and control are easy to use, quicker and accurate and can be used with objects or individuals to provide up-to-date pertinent information using methods such as on screen instructions, checklists, videos, pictures, diagrams, etc. or any combination thereof.

While the above descriptions contain several specifics these should not be construed as limitations on the scope of the invention, but rather as examples of some of the preferred embodiments thereof. Many other variations are possible. The variations could be used without departing from the scope and spirit of the novel features of the present invention.

Accordingly, the scope of the invention should be determined not by the illustrated embodiments, but by the appended claims and their legal equivalents.

We claim:

1. A computer server configured for use in a system for object recognition and control, the system comprising:
a) the server,
b) a network connected to the server, and
c) a plurality of handheld devices configured to be used by a plurality of users, each handheld device in communication with the server via the network, and each handheld device having a camera and a display,
the computer server comprising:
i) a database comprising:
(1) role data comprising a predetermined group of roles including use, maintenance, and observation,
(2) people data comprising identification information,
(3) object data comprising object specific information,
(4) task data comprising task specific information,
(5) task lists comprising collections of tasks associated with specific objects,
(6) device data comprising information associated with the hand held devices, and
ii) server programs for accessing, processing, and updating data stored in the database, comprising:
(1) a device identification program, comprising the steps of:
(a) requesting device identifying information from one of the plurality of handheld devices,
(b) using the device data and the device identifying information to identify a specific handheld device,
(c) storing information about the specific device and the communication with the device in the device data in the database, and
(d) determining characteristics of the specific handheld device,
(2) a user identification program, comprising the steps of:
(a) receiving user identifying information from the specific device,
(b) using the people data and the user identifying information to identify a specific user,
(c) storing information about the specific user and the interaction with the user in the people data in the database, and
(d) determining authorizations for the specific user from the role data in the database,
(3) an object identification program, comprising the steps of:
(a) receiving an object image from the specific device,
(b) using object recognition, the object data, and the object image to determine a specific object, and
(c) storing information about the specific object and the interaction with the specific object in the object data in the database,
(4) an authorization program, comprising the steps of:
(a) calling the device identification program to identify the specific device,
(b) calling the user identification program to identify the specific user,
(c) calling the object identification program to identify the specific object,
(d) determining whether the specific user is authorized to receive information associated with the specific object via the specific device,
(e) storing information about the specific user's interaction with the specific object in the user data and storing information about the specific object's interaction with specific user in the object data,
(5) a role determination program, comprising determining a specific role for the specific user with the specific object based on correlation of user data and object data,
(6) a plurality of procedure programs, comprising:
(a) a maintenance program, for providing control of maintenance of a specific physical maintenance object, having a plurality of parts, the maintenance program comprising the steps of:
(i) obtaining a task list from the task list data associated with the specific maintenance object, wherein the task list identifies at least one maintenance task from the task data, wherein the at least one maintenance task requires at least one part as a specific part and requires at least one tool as a specific tool, wherein the task data identifies instructions for using the specific part and the specific tool in the maintenance of the specific maintenance object,
(ii) using object recognition to identify the specific part required for maintenance of the specific object,
(iii) using object recognition to confirm that the specific part is present using images from the specific device being used by a specific maintenance user authorized to perform maintenance on the specific object,
(iv) identifying the specific tool required for maintenance of the specific object,
(v) using object recognition to confirm that the specific tool is present,
(vi) transmitting the identified maintenance instructions from the database to the specific device being viewed by the specific maintenance user, wherein the maintenance instructions are provided in a type and a format consistent with the characteristics of the specific device,
(vii) notifying a maintenance observer of the start of the maintenance task,
(viii) using object recognition to confirm use of the specific tool and the specific part in completion of the maintenance task,
(ix) notifying the maintenance observer of the completion of the maintenance task,
(x) storing in the object data information including the specific part, the specific tool, the specific maintenance user, and the maintenance observer, and
(xi) repeating steps (ii) through (x) until all tasks in the task list are completed,
(b) a use program, for providing control of use of the specific physical object, the use program comprising the steps of:
(i) obtaining a task list from the task list data associated with the specific object, wherein the task list identifies at least one task from the task data, wherein the task data identifies instructions for using the specific object,
(ii) determining if tools are required for the use of the specific object,
(iii) if a tool is required, using object recognition to confirm that the specific tool is present using images from a specific device being used by a specific user authorized to perform use on the specific object,
(iv) transmitting the identified use instructions from the database to the specific device being viewed by the specific user, wherein the use instructions are provided in a type and a format consistent with the characteristics of the specific device,
(v) notifying a use observer of the start of the use task,
(vi) using object recognition to confirm use of the specific object in completion of the use task,
(vii) notifying the use observer of the completion of the use task,
(viii) storing in the object data information including the specific object, the specific tool if required, the specific user, and the user observer, and
(ix) repeating steps (ii) through (viii) until all tasks in the task list are completed,
(c) an observation program, for providing control of observation of the specific observation object, the observation program comprising the steps of:
(i) obtaining an observation task list from the task list data associated with the specific object, wherein the observation task list identifies at least one observation task from the task data, wherein the task data identifies instructions for observing the specific object,
(ii) determining if instructions are required for the observation of the specific observation object by a specific user authorized to perform observation on the specific observation object,
(iii) if instructions are required, transmitting the identified observation instructions from the database to the specific device being viewed by the specific observation user, wherein the maintenance instructions are provided in a type and a format consistent with the characteristics of the specific device,
(iv) notifying another user of the start the observation,
(v) storing in the object data information including the specific object, the specific observation user, and the start and finish of observation, and
(vi) repeating steps (ii) through (v) until all tasks in the observation task list are completed.

2. A computer server configured for use in a system for object recognition and control, the system comprising:
a) the server,
b) a network connected to the server, and
c) a plurality of handheld devices configured to be used by a plurality of users, each handheld device in communication with the server via the network, and each handheld device having a camera and a display,
the computer server comprising:
i) a database comprising:
(1) role data comprising a predetermined group of roles including use, maintenance, and observation,
(2) people data comprising identification information,
(3) object data comprising object specific information,
(4) task data comprising task specific information, including object specific instructions,
(5) task lists comprising collections of tasks associated with specific objects, and
(6) device data comprising information associated with the hand held devices, and
ii) server programs for accessing, processing, and updating data stored in the database, comprising:
(1) a device identification program,
(2) a user identification program,
(3) an object identification program,
(4) an authorization program,
(5) a role determination program,
(6) a plurality of procedure programs, and
(7) a notification program.

3. The server of claim 2, wherein the device identification program comprises the steps of:
i) receiving device identifying information from one of the plurality of handheld devices,
ii) using the device data and the device identifying information to identify a specific handheld device,
iii) storing information about the specific device and the communication with the device in the device data in the database, and
iv) determining characteristics of the specific handheld device.

4. The server of claim 2, wherein the user identification program comprises the steps of:
i) receiving user identifying information from one of the plurality of handheld devices,
ii) using the people data and the user identifying information to identify a specific user,
iii) storing information about the specific user and the interaction with the user in the people data in the database, and
iv) determining authorizations for the specific user from the role data in the database.

5. The server of claim 2, wherein the object identification program comprises the steps of:
i) receiving an image from one of the plurality of handheld devices,
ii) using the object data and the received image to determine a specific object, and
iii) storing information about the specific object and the interaction with the object in the object data in the database.

6. The server of claim 2, wherein the authorization identification program comprises the steps of:
i) calling the device identification program to identify a specific device,
ii) calling the user identification program to identify a specific user,
iii) calling the object identification program to identify a specific object,
iv) determining whether the specific user is authorized to receive information associated with the specific object via the specific device, and
v) storing information about the specific user's interaction with specific object in the user data and storing information about the specific object's interaction with specific user in the object data.

7. The server of claim 2, wherein the role determination program comprises determining a specific role for a specific user with a specific object based on correlation of user data and object data.

8. The server of claim 2, wherein one of the procedure programs is a maintenance program, for providing control of maintenance of a specific physical object, having a plurality of parts, the maintenance program comprising the steps of:
a) obtaining a task list from the task list data associated with the specific object, wherein the task list identifies at least one task from the task data, wherein the at least one task requires at least one part as a specific part and requires at least one tool as a specific tool, wherein the task data identifies instructions for using the specific part and the specific tool in the maintenance of the specific object,
b) identifying the specific part required for the maintenance of the specific object,
c) receiving, from a specific device being used by a specific user authorized to perform maintenance on the specific object, a part confirmation image showing that the specific part is present,
d) identifying the specific tool required for the maintenance of the specific object,
e) receiving, from the specific device, a tool confirmation image showing that the specific tool is present,
f) transmitting the identified instructions from the database to the specific device being viewed by the specific user,
g) receiving, from the specific device, maintenance confirmation images of use of the specific tool and the specific part in completion of the maintenance task,
h) storing in the object data information including the specific part, the specific tool, and the specific user, and
i) repeating steps b) through h) until all tasks in the task list are completed.

9. The server of claim 8, wherein the maintenance program further comprises the steps of notifying an observer of the start or completion of the maintenance task.

10. The server of claim 2, wherein one of the procedure programs is a use program, for providing control of use of a specific physical object, the use program comprising the steps of:
a) obtaining a task list from the task list data associated with the specific object, wherein the task list identifies at least one task from the task data, wherein the task data identifies instructions for a use the specific object,
b) determining if tools are required for the use of the specific object,
c) if a tool is required, receiving, from a specific device being used by a specific user authorized to use the specific object, a tool confirmation image showing that the specific tool is present,
d) transmitting the identified instructions from the database to the specific device being viewed by the specific user,
e) receiving, from the specific device, use confirmation images showing use of the specific object in completion of the use task,
f) storing in the object data information including the specific object, the specific tool if required, and the specific user, and
g) repeating steps b) through f) until all tasks in the task list are completed.

11. The server of claim 10, wherein the use program further comprises the steps of notifying an observer of the start or completion of the use task.

12. The server of claim 2, wherein one of the procedure programs is an observation program, for providing control of observation of a specific object, the observation program comprising the steps of:
a) obtaining a task list from the task list data associated with the specific object, wherein the task list identifies at least one task from the task data, wherein the task data identifies instructions for observing the specific object,
b) determining if instructions are required for the observation of the specific object by a specific user authorized to perform observation on the specific object,
c) if instructions is required, transmitting the identified instructions from the database to a specific device being viewed by the specific user,
d) storing in the object data information including the specific object, the specific user, and the start and finish of observation, and
e) repeating steps b) through d) until all tasks in the task list are completed.

13. The server of claim 12, wherein the observation program further comprises the step of notifying another user of the start the observation.

14. The server of claim 4, wherein the user identification program recognizes an image of a face of the specific user.

15. The server of claim 5, wherein the object identification program uses object recognition artificial intelligence to recognize the specific object.

16. The server of claim 5, wherein the object identification program uses object recognition artificial intelligence to recognize a type of object associated with the specific object.

17. The server of claim 5, wherein the object identification program uses object recognition artificial intelligence to recognize a part the specific object.

18. The server of claim 5, wherein the object identification program uses object recognition artificial intelligence to recognize the specific object as a tool.

19. The server of claim 2, wherein the object specific instructions comprise a video with audio.

20. The server of claim 2, further comprising an artificial intelligence program,
wherein the artificial intelligence automatically observes all use and maintenance tasks associate with a specific object,
wherein the artificial intelligence notifies a user when the specific object is due for maintenance or use,
wherein the artificial intelligence notifies the user when a particular part or tool is missing, and
wherein the artificial intelligence notifies the user when a task has not been properly performed, and provides object specific instructions on how to properly complete the task.
